(19) United States
(12) Patent Application Publication
(10) Pub. No.: US 2023/0337769 A1
(43) Pub. Date: Oct. 26, 2023

(54) MULTIFUNCTIONAL LATEX ARTICLE

(71) Applicant: DIPPED PRODUCTS PLC, Colombo (LK)

(72) Inventors: Kariyapperuma Mudiyanselage Yasitha Udayanga KARIYAPPERUMA, Colombo (LK); Rendage Sachini Sandeepa CHANDRASIRI, Colombo (LK); Hasini Dinushika DANGALLE, Colombo (LK); Ratnayake Mudiyanselage Upul Nishantha RATNAYAKE, Colombo (LK)

(21) Appl. No.: 17/778,686

(22) PCT Filed: Nov. 28, 2020
(86) PCT No.: PCT/IB2020/061250

§ 371 Date: May 20, 2022

(30) Foreign Application Priority Data
Sep. 25, 2020 (LK) 21364

(51) Int. Cl. A41D 19/00; C09D 109/02; C09D 111/00; C09D 115/00; C09D 7/61; C09D 7/40; C09D 7/20; C09D 7/65; C09D 7/48; C09D 7/45; C09D 5/02; C09D 5/28; A41D 19/015

(52) U.S. Cl. CPC A41D 19/0006; C09D 109/02; C09D 111/00; C09D 115/00; C09D 7/61; C09D 7/67; C09D 7/20; C09D 7/65; C09D 7/48; C09D 7/45; C09D 5/02; C09D 5/28; A41D 19/01558; B29C 41/14

(57) ABSTRACT

A multi-layered multifunctional polymeric latex article is provided. A first polymeric latex layer, having nitrile butadiene, is resistant to chemical permeation whilst the second polymeric latex layer disposed on the first layer, being a composite layer of polychloroprene and Nano clay, is resistant to chemical degradation. The third layer disposed on the second layer is a polychloroprene layer having a unique micro-roughened surface texture pattern, providing an improved grip and friction in both wet and dry conditions. The second and third layers are disposed during the wet gelled stages of the first and second layers respectively. The gelled third layer is dipped in a solvent mixture whereby a chemical reaction causes the gelled surface of the third layer to texturize by swelling and fixing, creating a continuous and discontinuous wavy micro-roughened surface which is then cured causing formation of ionic crosslinks in the third polymeric layer.

### CROSS REFERENCE

The present invention is a non-provisional application claiming priority to Sri Lankan patent application number 21364 which was filed on Sep. 25, 2020 and entitled “MULTIFUNCTIONAL LATEX ARTICLE” and to International application number PCT/IB2020/061250 which was filed on Nov. 28, 2020 and entitled “MULTIFUNCTIONAL LATEX ARTICLE” both of which are incorporated by reference herein in its entirety.

### TECHNICAL FIELD

The present invention relates to multilayered polymeric latex articles, more particularly to an improved glove which is multifunctional, having chemical resistance, slow degradation and grip; and a method of manufacturing such article.

### BACKGROUND ART

Latex articles have various uses in various fields. More particularly in relation to use and protection from chemicals, latex gloves are used in various forms. In such latex articles, chemical resistance is a vital attribute. However, contact of chemicals also results in degradation of the article, thus reducing its useful lifetime and effectiveness. Therefore many synthetic latices with higher chemical resistance have been used in the production of chemical resistant gloves. Moreover, re-usable articles such as re-usable gloves require higher chemical resistance and the ability to withstand degradation caused every time the article comes in contact with chemicals. Thus re-usable latex articles require a higher degree of chemical resistance.

Further, it is also a beneficial feature of such articles to have a firm grip, providing resistance towards the slippery nature of a surface, especially under wet conditions. It is also apparent that aggressively textured articles provide users with a more firm and reliable grip.

In latex articles, more particularly in gloves, the traditional method of achieving grip is by using formers or molds with embossed patterns on the surface, which is ultimately transferred to the article. However, this approach results in less effective grip and due to dipping defects that occur at the tip defining the pattern, results in holes or prone to tears in the defective areas, which reduce the overall quality and reliability of the article.

Another commonly used method is creating crinkle s/textured structure on the surface of the article using organic solvents. Such crinkled/textured surfaces are common in Natural Rubber (NR) gloves, which is obtained by dipping the uncured glove in an organic solvent at the wet gel stage of the glove. The surface of the natural rubber is swelled by absorption of organic solvent molecules at the wet gel stage, resulting in a crinkled surface texture. However, this method is not common in synthetic latices due to the difficulty in achieving an effective texture.

Prior art reveals a variety of latex articles developed for use in relation to chemicals.

Japanese Patent JP2010133068 dated Aug. 12, 2008 for Chemical Resistant Glove by Showa Glove KK discloses a chemical resistant glove which comprises a polychloroprene-based rubber layer as a first layer and a mixed rubber layer containing a nitrile-butadiene-based rubber and a polychloroprene-based rubber as a second layer sequentially formed on a fabric glove. The slip resistance of the chemical resistant glove may be further improved by adding NBR-based rubber particles to the mixed rubber layer as the second layer. However, the two layers do not provide enough chemical resistance under various conditions. Some drawbacks of achieving slip resistance by incorporating rubber particles to the second layer are the possibility of detaching from the surface and less resistance under oily conditions.

U.S. patent Ser. No. 10/154,699 dated Aug. 9, 2016 for a Highly Chemical Resistant Glove by Ansell Uimited, discloses a chemical resistant composite glove that includes a first polymeric layer in the shape of a glove; and a second polymeric layer disposed on the first polymeric layer, and wherein the first polymeric layer is specified for one class of chemical resistance and the second polymeric layer is specified for a second class of chemical resistance, and optionally a third polymeric layer, which may be a thin coating, disposed on at least one of first polymeric layer or the second polymeric layer and is optionally specified for a third class of chemical resistance. In this product the NBR layer is textured with multi-faceted cavities formed by way of salt process-embedding. Some drawbacks of this system are that it involves a very tedious method and is not an environmentally friendly process. It could also result in non-uniform surface structure. Moreover, use of salt may cause corrosion and reduce the lifetime of the objects/equipment used. Further, it is evident from the thickness and shape of the article that this glove is a single use/disposable article and cannot be re-used for prolonged periods.

U.S. Patent publication No. 1983963A, describes a method of preparing a rubber product with a roughened or micro-roughened surface and a method for producing. The vulcanized skin of rubber is formed and the surface is treated with a rubber solvent or swelling agent such as naphtha, benzol, gasoline, etc., either by partial or complete immersion therein of the material or portions thereof desired to be roughened or micro-roughened or by subjecting the article or material to the fumes of such solvents or swelling agents. However this only provides grip and does not provide any protection from chemical permeation and degradation.

Although there are many types of chemical-resistant gloves available, most suffer the disadvantage of being rapidly degrading and lacking a reliable grip in wet and dry conditions.

### SUMMARY OF INVENTION

### Technical Problem

It is well known that absorption and swelling of organic molecules deteriorates the rubber molecules thereby reducing the chemical resistivity of a latex article. Thus latex articles made from natural rubber deteriorate faster than synthetic latices when they come in contact with chemicals and as such become unsuitable for re-usable latex articles such as re-usable gloves. However, the problem with using synthetic latices is the difficulty in obtaining a crinkled surface on it to provide a firm, reliable grip.

Embossed patterns made on a dipped article using formers or molds for the purpose of providing grip become inadequate and slippery in wet and oily conditions. The other commonly used method for creating crinkles or a textured structure using organic solvents is practical only in natural rubber gloves and not possible in most synthetic latices such as polychloroprene latex and nitrile butadiene rubber due to their low solubility in most organic solvents. Therefore, where a latex article is made using synthetic latices such as polychloroprene, creating crinkles on its surface using organic solvents becomes a challenge.

Thus, even though the chemical resistivity is achievable using synthetic latices like polychloroprene and nitrile butadiene rubber, it is difficult to achieve a firm grip by creating a textured or crinkled surface on them. Hence it is apparent that there is a critical need for a high chemical resistant latex article with a textured structure on the surface that provides both chemical resistance/slow degradation and firm grip and friction, especially for wet, dry and oily conditions, simultaneously. Accordingly, a more expeditious technique is needed for producing such article.

### Technical Solution

The present invention seeks to overcome the above problems by providing an improved re-usable multilayered latex article with a crinkled surface achieved on a synthetic latex film. In contrast to the prior art, the present invention incorporates both chemical resistivity and firm grip.

This is achieved by multiple polymeric latex composite layers disposed on one another, wherein the first polymeric layer comprises nitrile-butadiene, and the second polymeric composite layer comprising polychloroprene and layered Nano clay is disposed on the first polymeric layer and a third polymeric layer comprising polychloroprene is disposed on the second layer. The second polymeric composite layer is disposed on the first polymeric layer whilst the first polymeric layer is in its wet gel stage and the third polymeric layer is disposed on the second polymeric layer whilst the second polymeric layer is in its wet gel stage.

The third polymeric layer whilst in its wet gel stage is then dipped in a solvent mixture comprising methyl ethyl ketone (MEK), toluene and acetic acid. Toluene swells the polychloroprene layer whilst MEK acts on the swelled surface and creates the micro-roughness with continuous and discontinuous waves. The layered Nano clay, which is dispersed uniformly within the polychloroprene matrix and interacted with polychloroprene molecules, absorbs the solvent molecules into the clay gallery space and expands its volume by swelling. This swelling and interaction of layered Nano clay with polychloroprene molecules further facilitate creating the unique micro-roughness. The acid permanently fixes and retains the micro-roughened textured surface structure. In the curing process, the degree of crosslinking plays a vital role in creating textured surfaces. The ingredients in the compound of the second and third layers, more particularly Sulphur, forms covalent crosslinks with the double bonds while zinc forms ionic crosslinks with the chlorine atom during curing. The degree of ionic crosslinking is controlled by the use of ZnO as the only curing material which ensures the formation of only ionic crosslinks.

The synergistic effect of three different mechanisms which include swelling and fixing the polychloroprene latex surface with an organic solvent mixture, curing system to facilitate the formation of only ionic crosslinks and a composite of matrix made of layered Nano clay and polychloroprene latex results in the unique micro-roughness.

When in use, the first layer provides resistance to a number of chemicals including aliphatic hydrocarbons, acids and bases whilst the second layer provides additional reinforcement and better resistance towards chemical degradation and chemical permeation. The micro roughened surface provides enhanced grip under wet and dry conditions.

### Advantageous Effects

There are many advantages in using a multifunctional latex article as disclosed in the present invention.

Comparable latex articles disclosed in prior art, more particularly chemical resistant gloves, aren't necessarily multifunctional, in that they do not combine high chemical resistance and reliable grip all in one. This results in having to prioritize and pick the important function and pick a suitable glove for the purpose. Thus it is undesirable and would typically require different types of gloves.

Unlike in prior art, the article as disclosed requires no such focus on the requirement. This method prevents having to change the articles based on the use. Instead, a single article may be used for all purposes as it combines both high chemical resistance and reliable grip.

The article as disclosed also provides for a re-usable article. This is particularly beneficial for use in relation to chemicals without having to dispose frequently after use. Further, low degradation also contributes to the long life of the article, resulting in prolonged use which ultimately promotes environmental sustainability.

Such advantages are not found in other articles disclosed in prior art or products that are currently available in the market.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding summary of the invention in any manner. The Detailed Description will make reference to a number of drawings as follows:

FIG. 1 illustrates a side view of a glove according to an embodiment of the invention.

FIG. 2 illustrates a cross section of the article in FIG. 1.

FIG. 3 illustrates a cross section of a glove with a fabric support layer according to an embodiment of the invention.

FIG. 4 illustrates a top perspective view of the surface texture of an article according to embodiments of the invention.

FIG. 5 illustrates a flow diagram for a method of manufacturing articles according to embodiments of the invention.

FIG. 6 illustrates a flow diagram for another method of manufacturing articles with a fabric supported layer according to another embodiment of the invention.

### DESCRIPTION OF EMBODIMENTS

The present invention relates to a multilayered multifunctional polymeric latex article, particularly a synthetic latex glove with a unique micro-roughened surface textured polychloroprene (CR) outer surface with an improved grip and higher resistance towards chemical degradation.

In one aspect, the embodiments of the invention provide higher chemical resistance compared to existing products disclosed in prior art and in the market. In another aspect, the embodiments of the invention provide improved grip on a synthetic latex surface, compared to existing products disclosed in prior art and in the market.

The article is made of multiple polymeric latex composite layers wherein the inner layer (1st layer) is made of acrylonitrile butadiene (NBR) latex and the outer layers are made of poly chloroprene (CR).

Due to the composite characteristics of chemical resistance and grip, the invention may be embodied in gloves, floor mats, table mats etc.

The first layer is hereinafter sometimes referred to as the inner layer or the NBR layer or the first polymeric layer. The second layer is hereinafter sometimes referred to as the intermediate layer or the intermediate CR layer or the second polymeric layer. The third layer is hereinafter sometimes referred to as the micro-roughened layer or the third polymeric layer.

Nitrile latex is hereinafter sometimes abbreviated as NBR. Polychloroprene is hereinafter sometimes abbreviated as CR.

Preferred embodiments of the invention are described below by way of example only.

FIG. 1 illustrates a side view of a glove according to an embodiment of the invention. The third layer is seen to be covered up to the wrist level 100 whilst the first and/or the second layer extends beyond the wrist level 101.

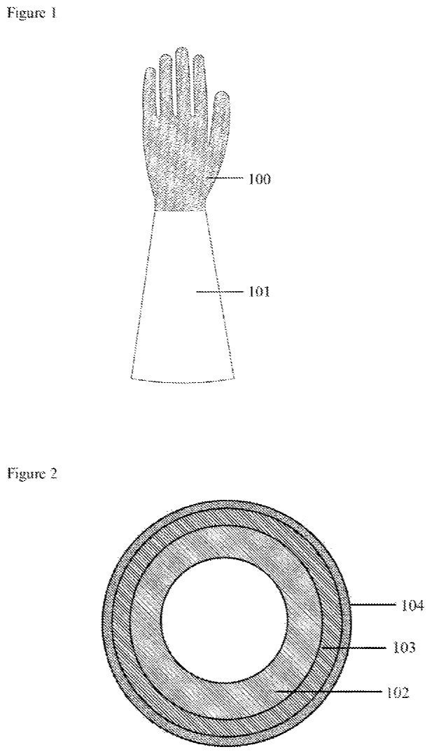

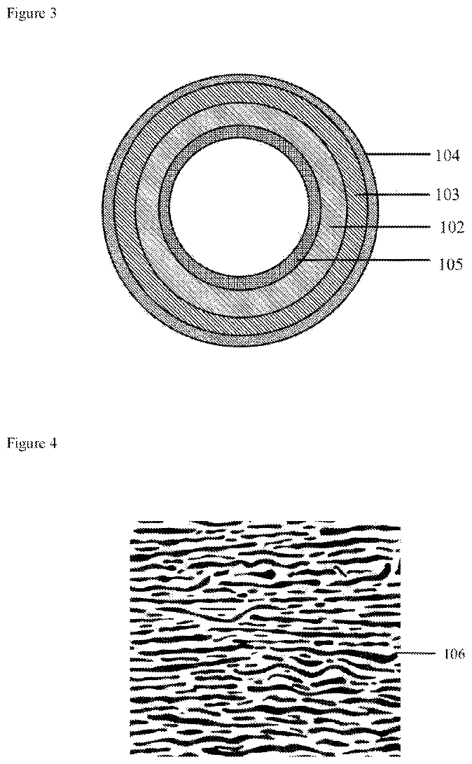

FIG. 2 illustrates a cross section of the article wherein the layers are shown. The inner or the first layer 102 of the article, which directly contacts with the skin is made of nitrile (NBR) latex. Its preferred thickness ranges between 0.38-0.55 mm. This layer provides protection from a number of chemicals including aliphatic hydrocarbons, acids and bases. In addition to the main polymeric NBR latex, the compound of this inner nitrile layer 102 comprises additives such as wetting agents, stabilizers, curing agents/system, activators, viscosity modifiers and pigments. The approximate Total Solids Content (TSC) of this layer ranges between 38-44%.

The preferred compound formulation used to prepare the NBR layer is as follows:

TABLE 1
Preferred composition of the inner nitrile layer

| | Parts per hundred |
|---|---|
| Ingredient | rubber (phr) value |
| Carboxylated Nitrile (NBR) Latex | 100.00 |
| Stabilizers | 0.80 |
| Dispersing agents | 0.30 |
| Sulfur | 2.80 |
| Accelerator | 1.60 |
| Zinc Oxide | 3.60 |
| Viscosity modifiers | 0.30 |
| Polymeric phenolic antioxidants | 0.75 |
| Pigments | 1.7 |

Carboxylated nitie (NBR) latex of the article formulation can be of low to high acrylonitrile containing latex grades or blends of the above grades.

Alternatively, the composition of this inner layer may also consist synthetic latices including and not limited to CR, styrene butadiene rubber (SBR), butyl rubber, polyvinyl chloride (PVC), and synthetic polyisoprene and natural rubber or blends of the above.

The intermediate or the second layer 103 is made of polychloroprene (CR) latex and is disposed on the NBR layer (first layer) 102 during the wet gel stage of the first layer 102. Applying the CR layer 103 at the wet gel stage ensures better adhesion to the NBR layer 102 and prevents detachment of the layers. The thickness of this CR layer 103 may range between 0.20-0.40 mm. This layer thus provides higher resistance towards chemical degradation against a range of chemicals including oxidizing acids, alcohols and alkali solutions. The compound formulation used to prepare the intermediate CR layer 103 has an approximate TSC of 50-55%. Wet-gel stage referred to herein is the un-dried polymeric latex layer which shows a soft gel-like structure.

A preferred compound formulation used to prepare the CR layer 103 is given below in Table 2.

TABLE 2
Preferred composition of the intermediate CR layer

| | Parts per hundred |
|---|---|
| Ingredient | rubber (phr) value |
| Polychloroprene Latex | 100.00 |
| Layered Nano clay | 1-10 |
| Stabilizers | 1.00 |
| Dispersing agents | 0.50 |
| Sulfur | 2.10 |
| Accelerator | 1.80 |
| Zinc Oxide | 5.60 |
| Viscosity modifiers | 0.20 |
| Polymeric phenolic antioxidants | 0.7 |
| Pigments | 2.6 |

Alternatively the composition of the second layer 103 may also comprise blends of CR with other natural and synthetic latices, including and not limited to nitrile butadiene rubber (NBR), styrene butadiene rubber (SBR), butyl rubber, polyvinyl chloride (PVC), and synthetic poly isoprene and natural rubber.

The intermediate CR layer 103 also comprises latex and layered Nano clay composite as shown in Table 2. The layered Nano clay referred to herein is smectite type layered clay material dispersed at nanometer scale range of 1-100 nm within the CR latex material. The preferred smectite type layered Nano clay used in this article is montmorillonite. However, other common smectite type layered clay such as rectorite, bentonite, hectorite, saponite, sauconite, vermiculite, laponite and kaolinite can also be used.

Addition of layered Nano clay minerals within the CR matrix provides an additional reinforcement to the ultimate product. The result of chemical and physical interaction between layered Nano clay and CR molecules thereby improves resistance towards chemical degradation and mechanical properties like abrasion resistance. The tortuous path created by the nano scale layered clay minerals within the CR latex matrix improves chemical resistance by increasing the time taken for a chemical to permeate through the second polymeric latex layer. Further, functional groups like hydroxyls, present in the layered clay mineral acts as an anchoring site and reacts with the carboxylic groups of the first NBR layer 102 and provide improved adhesion between the two layers.

It is important to have uniform dispersion of layered Nano clay within the CR matrix for better physical and chemical performances. The phr level of layered clay can be varied from 1-10 to achieve optimum mechanical and chemical properties. The main objective of adding layered Nano clay to the intermediate CR layer 103 is to provide additional reinforcement and better resistance towards chemical degradation and chemical permeation.

The outermost or the third layer 104 of the article is a micro-roughened, textured CR latex layer disposed on the second CR layer 103 during the wet gel stage of the second layer 103. Applying the outermost CR layer 104 at the wet gel stage ensures better adhesion between two CR latex layers and prevents detachment of the layers from each other. The micro roughness is formed by dipping the third CR layer 104 in a solvent mixture comprising methyl ethyl ketone (MEK), toluene and acetic acid at its wet gel stage. The thickness of the micro roughened textured CR layer 104 may range between 0.10-0.20 mm. The micro-roughened texture in the preferred thickness provides enhanced grip under wet and dry conditions. The total solid content of the compound of this third layer 104 is in the range of 52-54%.

Moreover, the unique micro-roughened textured surface 106 is created through ionic crosslinks and layered Nano clay in the CR latex. To ensure the formation of ionic crosslinks, ZnO acts as the only crosslinking agent as depicted in Table 3 below. It is also important to have the layered Nano clay to absorb the solvent molecules and thereby provide a controlled swelling which results in the unique surface texture. The preferred phr level of layered Nano clay within the 3rd CR layer 104 is from 1-5 phr.

Preferred compound formulations used to prepare the third CR layer 104 are given below in Table 3.

TABLE 3
Preferred composition of the micro-roughened CR layer

| | Parts per hundred rubber (phr) value | |
|---|---|---|
| Ingredient | Composition A | Composition B |
| Polychloroprene Latex | 100.00 | 100.00 |
| Stabilizers | 0.60 | 0.60 |
| Layered Nano clay | 1-5 | — |
| Dispersing agents | 0.30 | 0.30 |
| Zinc Oxide | 3.40 | 3.40 |
| Viscosity modifiers | 0.50 | 0.50 |
| Polymeric phenolic antioxidants | 0.7 | 0.7 |
| Pigments | 2.6 | 2.6 |

In another embodiment, the 3rd layer 104 may be constituted without layered Nano clay as depicted in composition B of Table 3.

FIG. 3 illustrates a cross section of a glove with a fabric support layer 105 according to an embodiment of the invention. The fabric layer 105 may be used to reinforce and provide additional support to an article. Accordingly the first NBR layer 102 is disposed on the fabric layer 105 and the intermediate CR layer 103 and the third CR layer 104 are disposed respectively as described above.

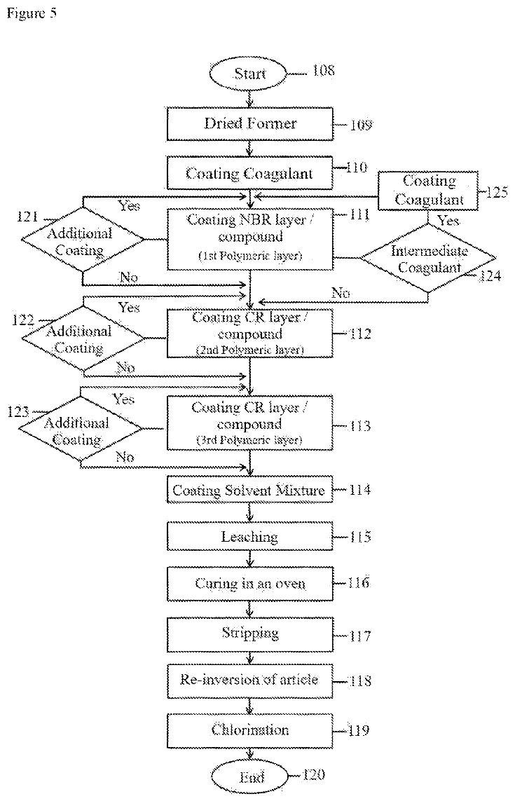

FIG. 4 illustrates a top perspective view of the surface texture of an article according to embodiments of the invention.

The unique micro-roughened textured surface is obtained by dipping the third CR layer 104 at the wet gem stage or before the third CR layer 104 is completely dried, in a mixture of organic solvents. The micro-roughened surface texture consists of continuous and discontinuous waves 106, usually comprising 20 to 100 discontinuous and 5 to 50 continuous waves per cm2. It is preferred if the surface comprises 20 to 40 discontinuous and 5 to 10 continuous waves per cm2, more preferably 40 to 60 discontinuous and 10 to 25 continuous waves per cm2, and most preferably 60 to 100 discontinuous and 25 to 50 continuous waves per cm2. The height of a single wave varies between 0.1 to 1 mm and it is more preferable if the height is between 0.4 to 0.6 mm.

The unique micro-roughened texture in the third layer is the result of a synergistic effect of the following three different mechanisms:
i. swelling and fixing the polychloroprene latex surface with an organic solvent mixture
ii. a curing system to facilitate the formation of only ionic crosslinks
iii. a composite of matrix made of layered Nano clay and polychloroprene latex

Swelling the surface of the natural rubber with organic solvents and thereby obtaining surface patterns is a common practice used in natural rubber. The organic solvent used here is a mixture, which contains a swelling component and a fixing component. The swelling component comprises an organic solvent such as toluene that swells the elastomeric/rubber, while the fixing component which comprises a weak acid such as acetic acid fixes the swelled surface and thereby creating a surface texture.

The solubility parameter is the key factor that affects the swelling of rubber. To properly swell the rubber it is important to have compatible or similar solubility parameter values between the solvent and elastomer or rubber, hence not all the solvents can be used for the swelling purpose. The commonly used solvents to swell the natural rubber (NR) includes toluene and turpentine in which solubility parameters are close to the solubility parameter of NR and hence natural rubber can be swelled easily. In the present invention, a novel solvent system is disclosed for polychloroprene (CR) latex using the combination of toluene and

methyl ethyl ketone (MEK) wherein the solubility parameter of the solvent mixture causes controlled swelling, leading to the unique micro-roughened textured surface on the third CR layer 104.

Table 4 illustrates the composition of the solvent mixture used to obtain the micro roughness on poly chloroprene surface.

TABLE 4
Composition of the solvent mixture

| Ingredient | Percentage % |
|---|---|
| Methyl ethyl ketone (MEK) | 25 |
| Toluene | 70 |
| Acetic acid | 5 |

Herein, toluene swells the polychloroprene layer to a certain degree and creates a roughness in the surface and the added MEK on the other hand acts on the swelled surface and creates the micro roughness with continuous and discontinuous waves 106. The MEK percentage can be varied from 10-40%, preferably 25%. Acetic acid is added as the fixing component to permanently fix and retain the unique micro-roughened textured surface structure. Acetic acid can be replaced with any other weak acid.

In another embodiment, MEK can be replaced with similar solvents such as turpentine, methyl isobutyl ketone, Xylene or any other solvent in which the solubility parameter of the solvent mixture creates a micro-roughened textured surface.

The degree of crosslinking plays a vital role in creating a textured surface, and thus it needs to be well controlled to achieve a defined surface texture or crinkle. The degree of crosslinking is mainly dependent on the curing system which primarily includes sulphur, accelerators and activators. In general, the curing system within the natural rubber forms covalent crosslinks between sulphur and double bonds in rubber molecules.

Polychloroprene (CR), being a synthetic rubber with a different molecular structure contains a double bond similar to natural rubber and a highly electronegative chlorine atom, providing the capability of forming both ionic and covalent crosslinks. Sulphur forms covalent crosslinks with the double bonds while zinc forms ionic crosslinks with the chlorine atom. [0063] Herein, the unique micro-roughened textured surface can only be achieved through ionic crosslinks. The degree of ionic crosslinking is controlled by the use of ZnO as the only curing material which ensures the formation of only ionic crosslinks.

The composite matrix made with layered Nano clay and polychloroprene is essential to obtain the unique micro-roughed textured surface. Once the gelled polychloroprene and layered Nano clay matrix is dipped in the solvent mixture that includes MEK, toluene and acetic acid, the layered Nano clay which is dispersed uniformly within the CR matrix and interacted with CR molecules, absorbs the solvent molecules into the clay gallery space and expands its volume by swelling. This swelling and interaction of layered Nano clay with CR molecules further facilitates the creation of unique micro-roughness on the surface of polychloroprene and the percentage of expansion or swelling determines the width and the height of the continuous and discontinuous waves 106.

FIG. 5 depicts a flow diagram for the methods of manufacturing an article having chemical resistance and a micro-roughened textured CR layer. The coating of layers may be done by dipping or spraying or any other suitable form.

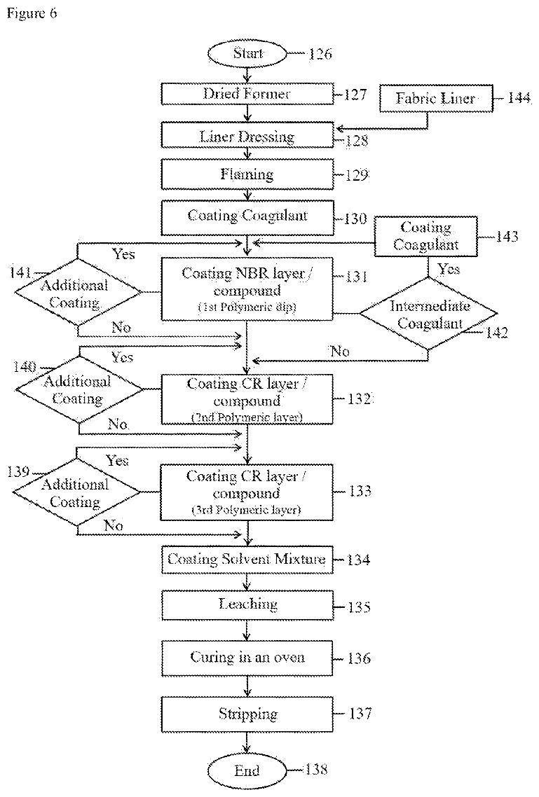

FIG. 6 depicts a flow diagram for manufacturing a fabric supported version of the article. The process starts with a dried former being dressed in a fabric liner. It may be dressed to the heated former manually and flamed to remove the excess billowed fibers. The fabric liner with the shape of the former, may comprise of natural and synthetic yams including and not limited to cotton, wool, polyester, rayon, nylon, acrylic, spandex, nylon 6, nylon 66 para and meta aramids such as Kevlar, ultra-high molecular weight polyethylene, high-performance polyethylene (HPPE) or any blend of these fibres and materials.

In both the fabric supported and non-supported articles, below steps will follow.

According to FIG. 5, the process starts 108 when the washed and dried former 109 in a temperature of 50 to 55° C. is coated with coagulant 110. Deposition of a calcium layer on the former will facilitate the formation of uniform polymeric latex layer on the former. The coagulant may be an aqueous or alcoholic solution with calcium nitrate of a concentration around 5-15%.

It is then coated in a NBR latex compound 111, comprising NBR latex and other additives such as wetting agents, stabilizers, curing agents, viscosity modifiers and pigments with an approximate Total Solid Content (TSC) of 38-44%. The compound is matured or kept in a resting time of 36 to 48 hours before using in the process. Coating this compound 111 will form a thin layer of nitrile on top of the former with a thickness of 0.38-0.55 mm. The thickness can be altered by the coagulant concentration, dwell time and number of coatings or dipping into the NBR latex compound. Optionally the NBR coated former may be dipped in a heated water tank of a temperature around 45-50° C. to remove excess calcium and other water soluble ingredients. Alternatively coating can be repeated 121 to obtain the desired thickness. Another alternative would be to produce an intermediate coagulant dip 124 and coat/dip in same 125 if the thickness of the first polymeric layer need to be further increased.

The second layer or the polychloroprene layer is coated 112 on top of the gelled NBR latex (1st layer) layer at its wet gel stage. The compound consists of CR latex and other additives such as wetting agents, stabilizers, curing agents, viscosity modifiers, layered Nano clay and pigments with an approximate TSC of 50-55%. The compound is matured or kept in a resting time of 48 to 96 hours before using in the process. Where the embodiment is a glove, the second layer may be coated 112 only up to the wrist area 100 indicating a length difference between the NBR layer 102 and CR layers 103,104. Alternatively the same compound can be coated two or more times 122 to get the desired thickness.

The third layer is coated 113 on top of the gelled second CR latex layer at its wet gel stage. The compound consists of CR latex and other additives such as wetting agents, stabilizers, curing agents, viscosity modifiers and pigments with an approximate TSC of 52-54%. The compound is matured or kept in a resting time of 96 hours before using in the process to get the desired surface texture. Alternatively the same compound can be coated two or more times 123 to get the desired thickness.

The gelled third layer is then dipped in a solvent mixture 114 of toluene, MEK and acetic acid, resulting in a micro-roughened textured surface with continuous and discontinuous waves 106. Where the embodiment is a glove, the third layer may be coated up to the wrist area 100 covering the length of the intermediate CR layer 103 and then well-dried to evaporate the excess solvents.

The article is then leached 115 in water at a temperature of approximately 50-55° C. to remove excess solvent, calcium nitrate and water soluble ingredients. The former is then cured 116 in an oven at 130-150° C. for 45 minutes, resulting in a cured multifunctional multilayered article. The finished article is stripped 117 from the formers manually and reinverted 118 to take the CR layer outward. This is only required in instances where a former is used for embodiments such as gloves. In other embodiments such as rugs re-inverting may not be required.

The final step of the process is chlorination 119 of the article, where the finished article is treated with chlorine water mixture and dried in an oven. In gloves, this facilitates easy donning of the glove by reducing the friction of the skin contacting surface of the glove. With this final step the process ends 120.

In embodiments where there is a fabric 105 supporting the article as shown in FIG. 6, chlorination and reinversion of the article (at the end) is not required. Accordingly, in the fabric supported article the process starts 126 when the dried former 127 is dressed 128 with a fabric liner 144 and flamed 129 and coated with coagulant 130. The rest of the steps are similar to the article (without the fabric layer) described above.

Accordingly, it is then coated in a NBR latex compound 131. Alternatively coating can be repeated 141 to obtain the desired thickness. Another alternative would be to produce an intermediate coagulant dip 142, 143 if the thickness of the first polymeric layer need to be further increased. Then the second layer or the polychloroprene layer is coated 132 on top of the gelled NBR latex (1st layer) layer at its wet gel stage. Alternatively the same compound can be coated two or more times 140 to get the desired thickness.

The third layer is coated 133 on top of the gelled second CR latex layer at its wet gel stage. Alternatively the same compound can be coated two or more times 139 to get the desired thickness. The gelled third layer is then dipped or coated in a solvent mixture 134 of toluene, MEK and acetic acid, resulting in a micro-roughened textured surface with continuous and discontinuous waves 106.

The article is then leached 135 in water at a temperature of approximately 50-55° C. to remove excess solvent, calcium nitrate and water soluble ingredients. The former is then cured 136 in an oven at 130-150° C. for 45 minutes, resulting in a cured fabric supported multifunctional multilayered article. The finished article is stripped 137 from the formers. This is only required in instances where a former is used for embodiments such as gloves. In other embodiments such as rugs re-inverting may not be required. With this final step 138 the process ends.

Resistance to chemical degradation is an important feature to consider when handling chemicals. According to Table 5 using a multilayered article with a micro-roughened surface as disclosed in this document provides improved resistance towards degradation than one rubber layer itself. Table 5 provides a comparison of the degree of chemical degradation in articles made of polychloroprene and NBR separately and in the articles disclosed in this document.

TABLE 5
Resistance towards chemical degradation

| | Percentage of degradation | | |
|---|---|---|---|
| | according to EN 374-4:2013 | | |
| | Mulit-layered | | |
| | Glove with | Poly- | |
| | micro-roughened | chloroprene | NBR |
| Solvent | surface | glove | glove |
| 96% Sulfuric Acid | 6 | 23.5 | 49.7 |
| 65% Nitric acid | 11.3 | 19.3 | 94.8 |
| 99% Acetic acid | 22.9 | 19.0 | 81.4 |
| Methanol | 20.1 | 3.8 | 76.9 |
| 40% Sodium Hydroxide | 1.6 | ~0.1 | ~23.5 |
| N-Heptane | 12.0 | 30.8 | 10.6 |

The performance of the glove for chemical permeation is measured according to EN ISO 374-1:2016 and the results are provided in Table 6 for identical thickness.

TABLE 6
Chemical performance

| | Permeation level | | |
|---|---|---|---|
| | according to EN ISO 374-1:2016 | | |
| | Mulit-layered | | |
| | article with | Poly- | |
| | micro-roughened | chloroprene | NBR |
| Solvent | surface | article | article |
| 96% Sulfuric Acid | 5 | 4 | 5 |
| 37% Hydrochloric acid | 6 | 6 | 6 |
| 65% Nitric acid | 6 | 6 | 3 |
| 99% Acetic acid | 6 | 5 | 4 |
| Methanol | 4 | 3 | 3 |
| 40% Sodium Hydroxide | 6 | 6 | 6 |
| N-Heptane | 6 | 1 | 6 |

The article with a micro-roughened surface displays a significant improvement over a wide range of chemicals compared to conventional polychloroprene and NBR gloves.

### INDUSTRIAL APPLICABILITY

Embodiments of the invention may be used in any field that uses chemicals in both dry and wet forms. Preferably in labs and factories, embodiments of the article may be used for protection from chemicals. Due to the combination of chemical resistance and reliable grip, this article is ideal for use in gloves. Additionally it also has uses in other forms of articles such as rugs and brushes/scours etc.

1. A multifunctional latex article comprising:
a first polymeric layer comprising a nitrile-butadiene material;
a second polymeric composite layer disposed on the first polymeric layer, comprising polychloroprene and layered Nano clay;
a third polymeric layer disposed on the second layer, comprising polychloroprene and a micro-roughened surface;
wherein the third layer is micro-roughened by dipping it in a solvent mixture comprising methyl ethyl ketone, toluene and acetic acid, at its wet gel stage; and in use the micro roughened surface provides grip whilst the second and third layers resist chemical degradation and the first layer resists chemical permeation.

2. The article according to claim 1 further comprising a fabric layer on which the first polymeric layer is disposed and wherein the surface texture of the micro roughened surface is continuous and discontinuous waves.

3. The article according to claim 1 wherein the third polymeric layer further comprises layered Nano clay and wherein the first polymeric layer is the skin contacting layer when used in a glove and the third polymeric layer is exposed to contact with chemicals.

4. (canceled)

5. (canceled)

6. (canceled)

7. The article according to claim 1 wherein the first polymeric layer comprises Carboxylated Nitrile butadiene Latex.

8. The article according to claim 1 wherein the compound of the first polymeric layer comprises Carboxylated Nitrile butadiene Latex, Stabilizers, Dispersing agents, Sulfur, Accelerator, Zinc Oxide, Viscosity modifiers, Polymeric phenolic-antioxidant, Pigments and has a total solid content of 38-44%.

9. The article according to claim 1 wherein the first polymeric layer is approximately 0.38-0.55 millimeters in thickness, the second polymeric layer is approximately 0.20-0.40 millimeters in thickness and the third polymeric layer is approximately 0.10-0.20 millimeters in thickness.

10. The article according to claim 1 wherein the compound of the second polymeric layer comprises polychloroprene, layered Nano clay, Sulfur, Accelerators, Zinc oxide, Viscosity modifiers, Stabilizers, Dispersing agents, Polymeric phenolic antioxidant, Pigment, and has a total solid content of 50-55%.

11. (canceled)

12. The article according to claim 1 wherein the compound of the third polymeric layer comprises polychloroprene, layered Nano clay, Zinc oxide, Stabilizers, Viscosity modifiers, Polymeric phenolic antioxidant, Pigment and dispersing agents and has a total solid content of 52-54%.

13. (canceled)

14. The article according to claim 1 wherein the third polymeric layer extends up to the wrist area or above when used in a glove.

15. A compound for a polymeric composite layer in a latex article, comprising:
80% Polychloroprene;
5% Nanoclay;
2% Sulfur;
4% Accelerators;
7% Zinc oxide;
0.1% Viscosity modifiers;
0.9% Polymeric phenolic antioxidant; and
1% Pigment.

16. The compound according to claim 15 wherein the total solid content is approximately 50-55%.

17. A method of forming a multifunctional latex article, comprising:
Applying a coagulant on a former;
Depositing a latex compound comprising Nitrile-Butadiene on the coagulant-coated former, forming a first polymeric layer;
Disposing a second polymeric composite layer comprising polychloroprene and layered Nano clay, on the first polymeric layer in its wet gel stage;
Disposing a third polymeric layer comprising polychloroprene, on the second polymeric composite layer in its wet gel stage;
Dipping the third polymeric layer in its wet gel stage into a solvent mixture comprising Toluene, Methyl Ethyl Ketone and Acetic acid;
Leaching the polymeric layers in water;
Curing the leached layers in an oven; and
Removing the layers from the former;
wherein the gelled third layer and the solvent mixture chemically react causing the gelled surface of the third layer to texturize the surface by swelling and fixing, creating a continuous and discontinuous wavy micro-roughened surface and curing causes formation of ionic crosslinks in the third polymeric layer.

18. The method according to claim 17 further comprising:
reinverting the article removed from the former to get the micro-roughened surface as the outer most layer;
chlorinating the article; and
disposing a fabric layer on the former before applying the coagulant.

19. (canceled)

20. (canceled)

21. The method according to claim 17 further comprising coating the first polymeric layer in coagulant before disposing the second layer on it, wherein the coagulant is an aqueous or alcohol solution having 5-15% of Calcium Nitrate.

22. (canceled)

23. The method according to claim 17 wherein the compound of the first polymeric layer comprises Carboxylated Nitrile butadiene Latex, Stabilizers, Dispersing agents, Sulfur, Accelerator, Zinc Oxide and Viscosity modifiers.

24. The method according to claim 17 wherein the first polymeric layer comprises a composition having a total solid content of 38-44%, the second polymeric layer comprises a composition having a total solid content of 50-55%, and the third polymeric layer comprises a composition having a total solid content of 50-54%.

25. The method according to claim 17 wherein the first layer is approximately 0.38-0.55 millimeters in thickness, the second layer is approximately 0.20-0.40 millimeters in thickness, and the third polymeric layer is approximately 0.10-0.20 millimeters in thickness.

26. The method according to claim 17 wherein the compound of the second polymeric layer comprises 80% polychloroprene, 5% Nano clay, 2% Sulfur, 4% Accelerators, 7% Zinc oxide, 0.1% Viscosity modifiers, 0.9% Polymeric phenolic antioxidant, and 1% Pigment, and the compound of the third polymeric layer comprises poly chloroprene, layered Nano clay, Zinc oxide, Viscosity modifiers and dispersing agents.

27. (canceled)

28. (canceled)

29. (canceled)

30. (canceled)

31. (canceled)

32. The method according to claim 17 wherein the solvent mixture comprises a constituent that supports swelling and a constituent that supports fixing.

33. The method according to claim 17 wherein the temperature of the water used for leaching is approximately 50-55° C. and the layers are cured in an oven at 130-150° C. for 45 minutes.

34. (canceled)
